(19) United States
(12) Patent Application Publication
(10) Pub. No.: US 2010/0215470 A1
(43) Pub. Date: Aug. 26, 2010

(54) TRANSPORTATION APPARATUS

(75) Inventors: RONG-MOU BAO, Shenzhen City (CN); GA-LEI HU, Shenzhen City (CN); DE-BING WANG, Shenzhen City (CN); CHI-CHUNG LIU, Tu-Cheng (TW); JIAN-LONG XING, Shenzhen City (CN); CHUN-NAN OU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUCTRY (ShenZhen) CO., LTD, ShenZhen City (CN); HON HAI PRECISION INDUSTRY CO., LTD., Tu-Cheng (TW)

(21) Appl. No.: 12/506,427

(22) Filed: Jul. 21, 2009

(30) Foreign Application Priority Data
Feb. 25, 2009 (CN) 200920300866.9

(51) Int. Cl. B65G 49/00

(52) U.S. Cl. 414/749.6

(57) ABSTRACT

A transportation apparatus includes a base, a pair of guideways fixed on the base in parallel, a rodless cylinder installed on one of the pair of guideways and including a sliding block operable to be driven by the rodless cylinder to slide along one of the pair of guideways, a supporting member fixed on the sliding block, a lift cylinder installed on the supporting member, and a manipulating member installed on the cylinder. Each of two opposite sides of the supporting member is configured with an upper roller and a side roller abutting against an upper side and an inner side of one of the pair of the guideways, respectively. The manipulating member is operable to be driven by the cylinder to move along a direction different from an extending direction of the pair of guideways.

### BACKGROUND

1. Technical Field

The disclosure relates to transportation apparatuses, and more particularly to an transportation apparatus driven by cylinders.

2. Description of Related Art

In a factory, commonly used transportation apparatuses are driven by motors in accompany with gear systems or chain systems, to convey workpieces from one place to another. However, the transportation apparatuses with the gear systems usually have complex mechanical configurations and high costs to maintain.

Therefore, a need exists in the industry to overcome the described limitations.

### BRIEF DESCRIPTION OF THE DRAWINGS

FIG. 1 is an assembled, perspective view of a transportation apparatus in accordance with an exemplary embodiment of the disclosure.

FIG. 2 is an enlarged view of the transportation apparatus shown in FIG. 1, in which a base and a pair of guideways are not shown.

FIG. 3 is an enlarged view of a segment III shown in FIG. 1.

FIG. 4 is similar to FIG. 3, but viewed from another aspect.

### DETAILED DESCRIPTION

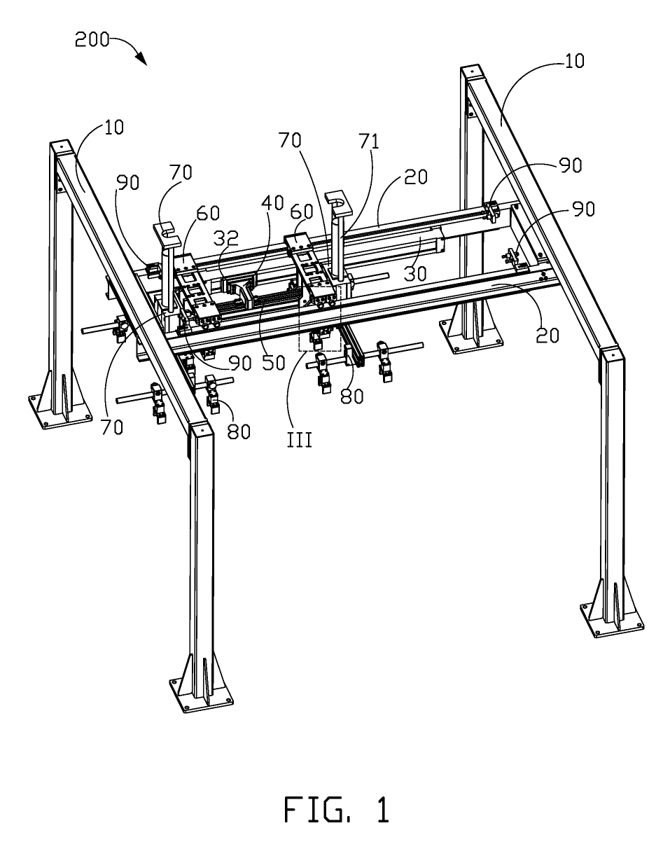

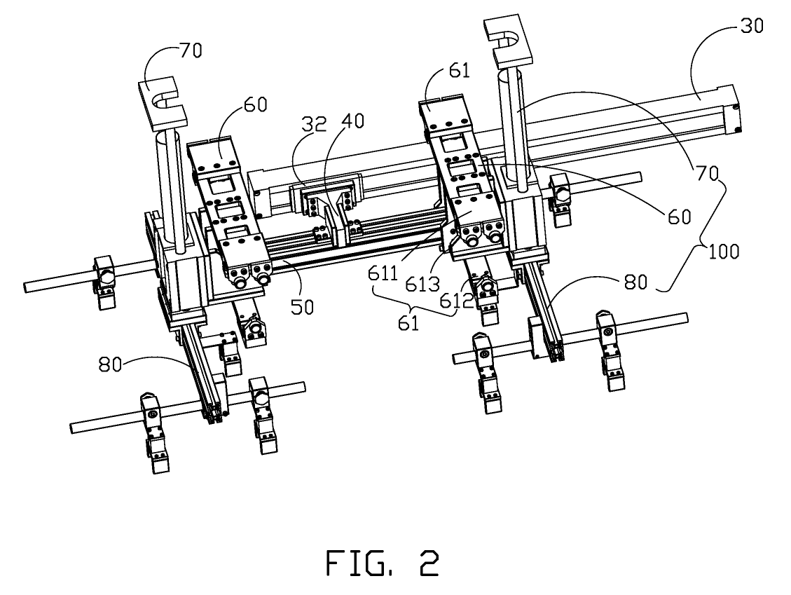

Referring to FIG. 1 and FIG. 2, an exemplary embodiment of transportation apparatus 200 to convey workpieces from one place to another place, is disclosed. The transportation apparatus 200 includes a base 10 fixed to ground, a pair of guideways 20, a rodless cylinder 30 installed on the guideways 20, a connection block 40, a connection arm 50, and at least one transportation cell 100 transmitting the workpieces. In the illustrated embodiment, the transportation apparatus 200 includes two transportation cells 100.

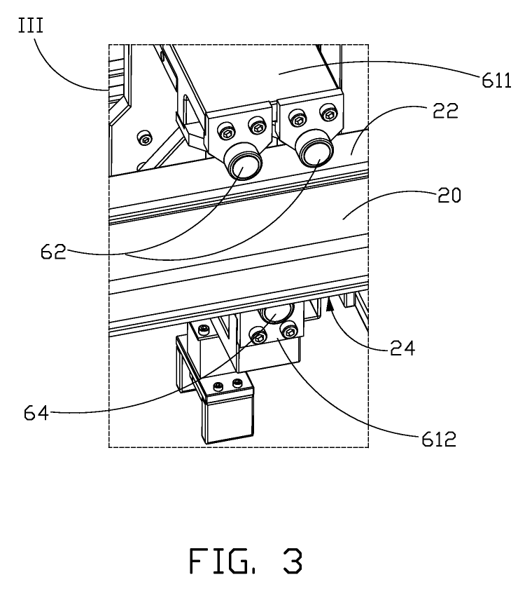

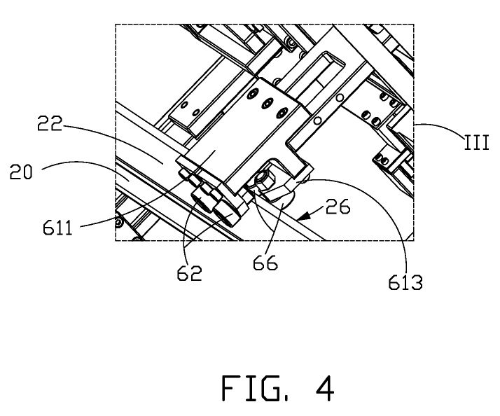

The pair of guideways 20 are installed on the base 10 in parallel. Each of the pair of guideways 20 includes an upper side 22, a lower side 24 on another side of the 20, and an inner side 26 connected between the upper side 22 and the lower side 24 (refer to FIG. 3 and FIG. 4). The rodless cylinder 30 is installed on the inner side 26 of one of the pair of the guideways 20, and includes a sliding block 32 drivable by the rodless cylinder 30 to slide along the one of the pair of guideways 20. Alternatively, the rodless cylinder 30 may be fixed on the lower side 24 of one of the pair of the guideways 20.

The connection block 40 is fixed on the sliding block 32, and the connection arm 50 is fixed on the connection block 40. In an alternative embodiment, the connection arm 50 is directly fixed on the sliding block 32, such that the connection block 40 is omitted. The two transportation cells 100 are fixed on the connection arm 50 and slidably located at the pair of guideways 20. In detail, the two transportation cells 100 are connected to the sliding block 32 via the connection arm 50 and are spaced from each other. When the rodless cylinder 30 drives the sliding block 32 to slide along the guideways 20, the transportation cells 100 slide along the guideways 20 correspondingly. A distance between the two transportation cells 100 can be adjusted according to practical requirements.

In the exemplary embodiment, each of the two transportation cells 100 includes a supporting member 60 fixed on the connection arm 50 and slidably located at the pair of guideways 20, a lift cylinder 70 fixed on the supporting member 60, and a manipulating member 80 fixed on a piston 71 of the lift cylinder 70. When the lift cylinder 70 drives the piston 71 to move along a direction different from the extending direction of the pair of guideways 20, the manipulating member 80 moves correspondingly. In this way, when the lift cylinder 70 and the rodless cylinder 30 operate collectively, the manipulating member 80 is driven to transmit the piece from one location to another.

Referring to FIG. 2 to FIG. 4, the supporting member 60 includes two opposite sides 61. Each of the two opposite sides 61 includes an upper portion 611, a side portion 613 perpendicular to the upper portion 611, and a lower portion 612 parallel to the upper portion 611. The upper portion 611 of each of the two opposite sides 61 of the supporting member 60 is configured with at least one upper roller 62 abutting against the upper side 22 of one of the pair of guideways 20. The side portion 613 of each of the two opposite sides 61 of the supporting member 60 is configured with at least one side roller 66 abutting against the inner side 26 of one of the pair of guideways 20. In this position, the supporting member 60 slides along the pair of guideways 20.

In the illustrated embodiment, two upper rollers 62 and two side rollers 66 are configured at the upper portion 611 and the side portion 613 of each of the two opposite sides 61 of the supporting member 60, respectively, which ensures the supporting members 60 to slide along the pair of guideways 20 smoothly.

Alternatively, the lower portion 612 of each of the two opposite sides 61 of the supporting member 60 is configured with a lower roller 64 abutting against the lower side 24 of one of the pair of guideways 20. In this position, the pair of guideways 20 are disposed between the upper rollers 62 and the lower rollers 64, such that the supporting member 60 is limited to move along directions perpendicular to the extending direction of the pair of guideways 20. Thus, the transportation apparatus 100 moves along the pair of guideways 20 smoothly.

In an exemplary embodiment, the transportation apparatus 200 includes two position restriction members 90 respectively located at two ends of the pair of guideways 20. The position restriction members 90 are positioned to prevent the lift cylinders 70 from interfering with the base 10 when the transportation apparatus 200 transmits the workpieces.

In use, when the transportation apparatus 200 conveys workpieces from one place to another place, the lift cylinder 70 drives the manipulating member 80 to move and pick up the workpieces, then, the rodless cylinder 30 drives the sliding block 32 and the transportation cell 100 to slide along the guideways 20. When the transportation cell 100 arrives at a destination, the lift cylinders 70 drives the manipulator member 80 to lay down the workpieces at the destination. In this position, the workpieces are conveyed to the destination by the transportation apparatus 200.

The transportation apparatus 200 of this disclosure is driven by cylinders, thus, the transportation apparatus 200 has a simple mechanical configuration, resulting in short development cycle and low cost.

While exemplary embodiments have been described, it should be understood that it has been presented by way of example only and not by way of limitation. The breadth and scope of the disclosure should not be limited by the described exemplary embodiments, but only in accordance with the following claims and their equivalent.

What is claimed is:

1. A transportation apparatus to transmit workpieces, comprising:
a base;
a pair of guideways fixed on the base in parallel, each of the pair of guideways comprising an upper side, a lower side opposite to the upper side, and an inner side connected between the upper side and the lower side;
a rodless cylinder installed on one of the pair of guideways, the rodless cylinder comprising a sliding block drivable by the rodless cylinder to slide along the one of the pair of guideways;
a supporting member fixed on the sliding block and slidably located at the pair of the guideways, wherein each of two opposite sides of the supporting member is configured with a upper roller and a side roller abutting against the upper side and the inner side of one of the pair of the guideways, respectively;
a lift cylinder installed on the supporting member; and
a manipulating member installed on the lift cylinder and operable to be driven by the lift cylinder to move along a direction different from a extending direction of the pair of guideways.

2. The transportation apparatus as claimed in claim 1, wherein each of two opposite sides of the supporting member is further configured with a secure roller abutting against the lower side of corresponding one of the pair of guideways.

3. The transportation apparatus as claimed in claim 1, further comprising two position restriction members located at two ends of the pair of guideways, respectively, to prevent the lift cylinder from interfering with the base.

4. The transportation apparatus as claimed in claim 1, further comprising another supporting member, wherein the supporting members are fixed on a connection arm that is fixed on the sliding block.

5. The transportation apparatus as claimed in claim 4, further comprising another lift cylinder, wherein the lift cylinders are respectively installed on the supporting members.

6. The transportation apparatus as claimed in claim 5, further comprising another manipulating member, wherein the manipulating members are respectively installed on the lift cylinders.
